(19) United States
(12) Patent Application Publication
(10) Pub. No.: US 2020/0114479 A1
(43) Pub. Date: Apr. 16, 2020

(54) SPRING LOAD ADJUSTING METHOD

(71) Applicant: DENSO CORPORATION, Kariya-city (JP)

(72) Inventor: Masato UENO, Kariya-city (JP)

(21) Appl. No.: 16/598,390

(22) Filed: Oct. 10, 2019

(30) Foreign Application Priority Data
Oct. 12, 2018 (JP) 2018-193172

(51) Int. Cl. B23P 15/00; F16K 31/06; B21D 39/04

(52) U.S. Cl. CPC B23P 15/001; B21D 39/048; F16K 31/0658

(57) ABSTRACT

A linear solenoid valve has a spring member and a spring load adjusting member, which is screwed into a sleeve member of the linear solenoid valve in order to adjust a spring load of the spring member. The sleeve member has a female screw portion and a swaged-claw forming portion is formed at an axial end surface of the female screw portion. Multiple swaging punches are prepared, each of which has a punching tooth portion of a punching portion. A punching area of the punching tooth portion differs from the swaging punch to the swaging punch. One of the multiple swaging punches is selected depending on a press-direction distance between the swaged-claw forming portion and an axial end surface of the adjust screw member. When the press-direction distance is smaller than a predetermined distance range, the swaging punch having a larger punching area for the punching tooth portion is selected, wherein the punching area is larger than a punching area of another swaging punch which is selected when the press-direction distance is larger than the predetermined distance range.

### CROSS REFERENCE TO RELATED APPLICATION

This application is based on Japanese Patent Application No. 2018-193172 filed on Oct. 12, 2018, the disclosure of which is incorporated herein by reference.

### FIELD OF TECHNOLOGY

The present disclosure relates to a method for adjusting a spring load.

### BACKGROUND

A spring load adjusting device is known in the art, according to which a female screw portion is formed in a sleeve member and an adjust screw member having a male screw portion is screwed into the female screw portion of the sleeve member, so that a spring load is adjusted by adjusting a position of the adjust screw member relative to the sleeve member. When the spring load adjusting device is applied to a spool valve unit, which is used as one of components for a hydraulic control apparatus, for example, for an automatic transmission apparatus of an automotive vehicle, a high sealing property is required between the sleeve member and the adjust screw member.

According to a spring load adjusting method by use of one of the spring load adjusting devices known in the art, an axial end of the sleeve member is swaged by plastic deformation to an axial end of the adjust screw member and a swaged portion is formed, after an axial position of the adjust screw member is adjusted along a spring biasing direction and thereby a spring load is adjusted. The axial position of the adjust screw member is fixed by the swaged portion in a press direction of the adjust screw member. The adjust screw member is pushed in the press direction. A sealing property is ensured between the sleeve member and the adjust screw member.

According to one of the prior art methods for adjusting the spring load, the axial end of the sleeve member is plastically deformed to the axial end surface of the adjust screw member to form the swaged portions. A force necessary for the plastic deformation varies depending on the axial position of the adjust screw member relative to the sleeve member after the adjustment of the spring load. In a case that a swaging load to be applied to a swaging punch is constant, the force applied to the adjust screw member becomes smaller as the force necessary for the plastic deformation becomes larger. Then, a force for fixing the adjust screw member by the swaged portions may become insufficient and thereby the sealing performance may be decreased. On the other hand, the force applied to the adjust screw member becomes larger as the force necessary for the plastic deformation becomes smaller. Then, a buckling may occur in the adjust screw member or in the sleeve member, or the swaged portions or portions around the swaged portions may be damaged.

### SUMMARY OF THE DISCLOSURE

The present disclosure is made in view of the above problem. It is an object of the present disclosure to provide a method for adjusting the spring load, according to which swaged claws can be properly formed independently from the position of the adjust screw member relative to the sleeve member after the adjustment of the spring load, the high sealing performance is obtained between the sleeve member and the adjust screw member, and the spring load can be adjusted in a wider range.

According to one of features of the present disclosure, multiple swaging punches are prepared, wherein each of the swaging punches has a punching portion having a punching area different from the swaging punch to the swaging punch. One of the swaging punches is selected depending on a press-direction distance between an axial end surface of a sleeve member and an axial end surface of an adjust screw member. A swaging load is applied to the selected swaging punch to plastically deform a part of an axial end portion of the sleeve member, so that a swaged claw is formed on the axial end surface of the adjust screw member. The adjust screw member is pushed by the swaged claw in an axial direction to achieve a high sealing performance between the sleeve member and the adjust screw member.

According to another feature of the present disclosure, a swaging punch of one kind is prepared and a swaging load is applied to the swaging punch. A value of the swaging load is changed depending on a press-direction distance between an axial end surface of a sleeve member and an axial end surface of an adjust screw member.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic cross-sectional view showing a linear solenoid valve having a spring load adjusting device according to a first embodiment of the present disclosure;

FIG. 2 is a schematically enlarged cross-sectional view showing the spring load adjusting device of FIG. 1;

FIG. 3 is a schematic front view showing the spring load adjusting device, in which swaged claws are formed;

FIG. 4 is a schematic cross-sectional view taken along a line IV-IV in FIG. 3;

FIG. 5 is a schematic cross-sectional view showing a process for forming swaged claws;

FIG. 6 is a graph for explaining a relationship between a distance in a press direction and a load applied to a swaging punch;

FIG. 7 is a process chart showing steps for a method of adjusting a spring load of the spring load adjusting device;

FIG. 8 is a schematic front view showing the spring load adjusting device, in which swaged claws are formed by the swaging punch having a larger circumferential width;

FIG. 9 is a schematic front view showing the spring load adjusting device, in which swaged claws are formed by a swaging punch having a smaller circumferential width;

FIG. 10 is a graph for explaining the relationship between the distance in the press direction and the load applied to the swaging punch, in a case that a selected swaging punch is used;

FIG. 11 is a schematic front view showing the spring load adjusting device according to a second embodiment, in which swaged claws are formed by a swaging punch having a larger radial width;

FIG. 12 is a schematic front view showing the spring load adjusting device according to a third embodiment, in which swaged claws are formed by a swaging punch having a larger number of punching teeth portions;

FIG. 13 is a process chart showing steps for the method for adjusting the spring load according to a fourth embodiment; and

FIG. 14 is a graph for explaining the relationship between the distance in the press direction and the load applied to the swaging punch according to the fourth embodiment.

### DETAILED DESCRIPTION OF THE EMBODIMENTS

The present disclosure will be explained hereinafter by way of multiple embodiments and/or modifications with reference to the drawings. The same reference numerals are given to the same or similar structures and/or portions in order to avoid repeated explanation.

### First Embodiment

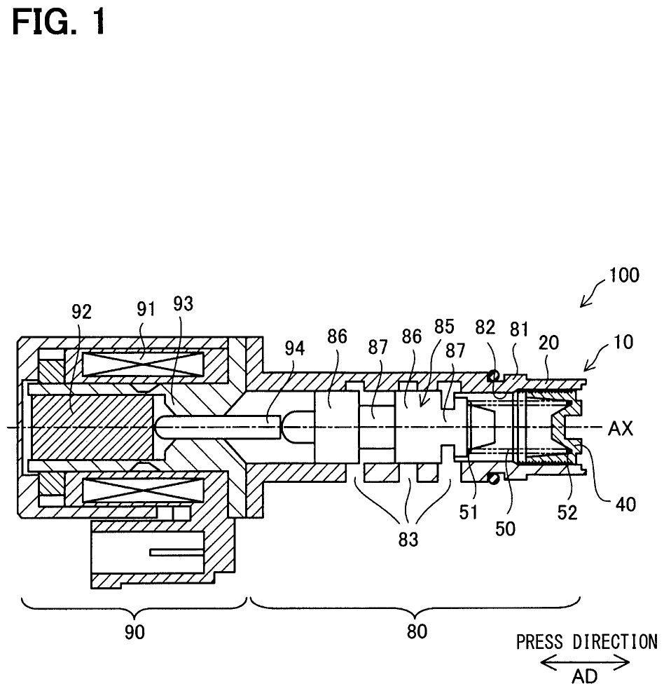

As shown in FIG. 1, a spring load adjusting device 10 for a spring load adjusting method of a first embodiment is applied to a spool valve unit 80 of a linear solenoid valve 100 and adjusts a spring load for the spool valve unit 80. The linear solenoid valve 100 is used for controlling oil pressure of working oil to be supplied to, for example, an automatic transmission apparatus (not shown) for an automotive vehicle. More exactly, the linear solenoid valve 100 is provided in a hydraulic circuit (not shown) for the automatic transmission apparatus. The linear solenoid valve 100 includes the spool valve unit 80 and an electromagnetic unit 90, which are coaxially arranged with each other in an axial direction (a center axis AX) of the linear solenoid valve 100.

The spool valve unit 80 controls an opened or closed condition of each oil port 83 (explained below) and adjusts an open area thereof. The spool valve unit 80 includes a sleeve member 81, a spool member 85, a spring member 50 and the spring load adjusting device 10.

The sleeve member 81 is formed in a cylindrical shape. The sleeve member 81 includes a spool accommodation hole 82 extending along the center axis AX and multiple oil ports 83, each of which is extending in a radial direction (perpendicular to the center axis AX) of the sleeve member 81 and communicated to an inside of the spool accommodation hole 82. The spool member 85 is movably inserted into the spool accommodation hole 82, so that the spool member 85 is movable therein in the axial direction. The spool member 85 is formed in a rod shape, in which large-diameter portions 86 and small-diameter portions 87 are alternately formed in the axial direction of the center axis AX. When the spool member 85 is moved in the axial direction, each of the oil ports 83 is operatively opened or closed and the opening degree of the opened oil port 83 is controlled depending on axial positions of the respective large-diameter portions 86 and the small-diameter portions 87 in the axial direction of the center axis AX. The multiple oil ports 83 are arranged along a line parallel to the center axis AX (which is also referred to as a press direction AD). The multiple oil ports 83 include an inlet port connected to an oil pump (not shown) so that the working oil is supplied to the inlet port, an outlet port connected to a clutch device (not shown) of the automatic transmission apparatus so that the working oil is supplied thereto, and a drain port for discharging the working oil to an outside of the spool valve unit 80. One of axial ends of the sleeve member 81, that is, an axial end of a right-hand side in the drawing opposite to the other axial end of a left-hand side connected to the electromagnetic unit 90, works as a female screw member 20 of the spring load adjusting service 10 (explained below). The spring member 50 is composed of a compression coil spring. One of coil ends of the spring member 50 (a coil end 51 of the left-hand side) is in contact with an axial end of the spool member 85 (an axial end of the right-hand side) and is supported by the axial end of the spool member 85. The spring member 50 biases the spool member 85 in the axial direction (in the press direction AD) to the electromagnetic unit 90. A leftward direction is hereinafter referred to as a first axial direction. The spring load adjusting device 10 is provided at the axial end of the spool valve unit 80 (the axial end of the right-hand side) opposite to the axial end of the left-hand side connected to the electromagnetic unit 90.

The electromagnetic unit 90 drives the spool valve unit 80. The electromagnetic unit 90 is connected to an electronic control unit (not shown; hereinafter, the ECU) and controlled by the ECU. When electric power is supplied to the electromagnetic unit 90, an electromagnetic coil 91 is excited to generate an electromagnetic field and a plunger 92 is attracted by the electromagnetic field in the axial direction to an attracting core 93 (in a rightward direction; hereinafter, a second axial direction). Then, a pushing force is applied from the plunger 92 to the spool member 85 via a shaft member 94. This pushing force is applied to the spool member 85 in the second axial direction opposite to the first axial direction of the biasing force of the spring member 50. As a result, an axial position of the spool member 85 in the press direction AD is changed relative to the sleeve member 81 when the electric power is supplied to the electromagnetic unit 90 and thereby the opened or closed condition of each oil port 83 as well as the opening degree of the opened oil port 83 is changed. Accordingly, the oil pressure is outputted in proportion to a current value of the electric power.

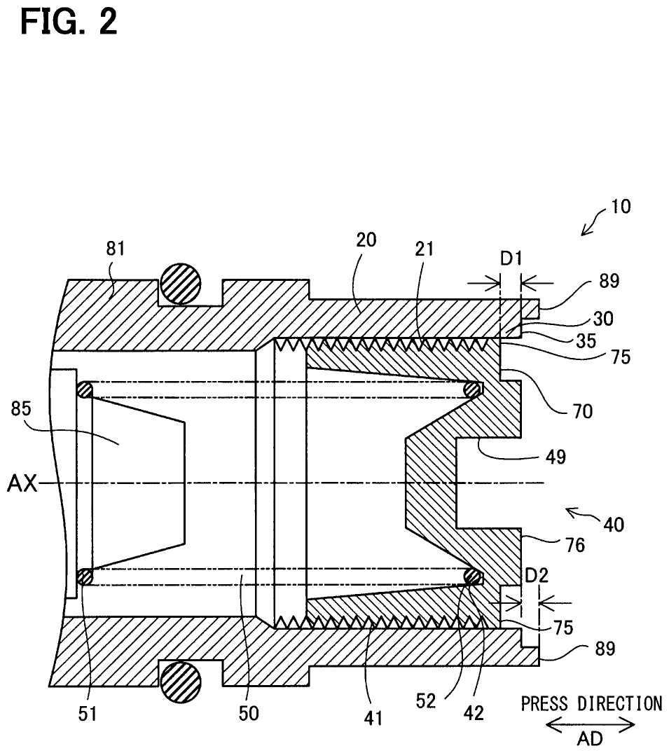

As shown in FIG. 2, the spring load adjusting device 10 includes the female screw member 20, which is a part of the sleeve member 81, and an adjust screw member 40. FIG. 2 shows a cross section of the spring load adjusting device 10 including the center axis AX in a condition that swaged claws 60 (explained below) are not formed.

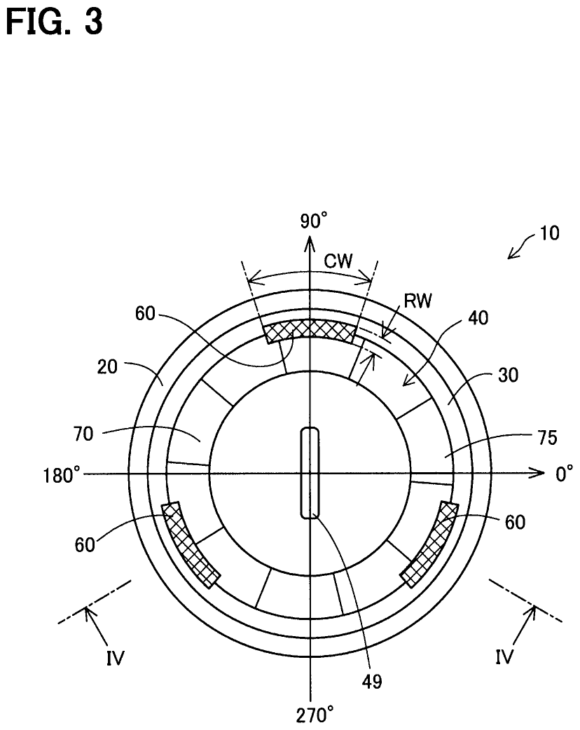

The female screw member 20 is formed in a cylindrical shape and a female screw 21 is formed at an inner peripheral surface of the female screw member 20. The female screw member 20 has a swaged-claw forming portion 30 at its axial end in the press direction AD, more exactly, at the axial end in the press direction AD on a side opposite to the electromagnetic unit 90 shown in FIG. 1 (a right-hand side in the drawing). The swaged-claw forming portion 30 outwardly extends in the second axial direction from the inner peripheral surface of the female screw member 20. When the swaged-claw forming portion 30 is plastically deformed in a radial-inward direction by a swaging punch 220 (explained below), multiple swaged claws 60 (as shown in FIG. 3 and other drawings) are formed, so that an axial end surface 70 of the adjust screw member 40 is firmly held in the axial direction (fixed to the female screw member 20). Each of the swaged claws 60 not only fixes an axial position of the adjust screw member 40 in the press direction AD but also pushes the adjust screw member 40 in the first axial direction (in the press direction AD from the spool member 80 to the electromagnetic unit 90). The swaged-claw forming portion 30, the swaged claws 60 and the swaging punch 220 will be further explained below.

As shown in FIG. 2, the adjust screw member 40 is formed in a cylindrical shape having a closed end at its right-hand end and inserted into an inside of the female screw member 20. The adjust screw member 40 includes a male screw 41, a spring holding portion 42, the axial end surface 70, a tool insertion portion 49 and so on. The male screw 41 is formed in a spiral form at an outer peripheral surface of the adjust screw member 40, so that the male screw 41 is engaged with the female screw 21 formed in the female screw member 20. The spring holding portion 42 is formed at a bottom portion (a right-hand bottom wall) of the adjust screw member 40 and holds one of axial ends (a right-hand end 52) of the spring member 50.

The axial end surface 70 forms an end surface of the adjust screw member 40 in the press direction AD on a right-hand axial end opposite to another axial end (a left-hand axial end) facing the electromagnetic unit 90 (shown in FIG. 1). A press-force receiving portion 75 is formed at an outer peripheral portion of the axial end surface 70. The press-force receiving portion 75 is firmly held in the axial direction by the swaged claws 60. The tool insertion portion 49 is formed at a center of the axial end surface 70, to which a tool (not shown) is inserted in an assembling process of the adjust screw member 40 to the sleeve member 81. In the present embodiment, the tool insertion portion 49 is formed in a longitudinal groove having a rectangular cross-sectional shape on a plane perpendicular to the axial direction, into which a flat-blade screw driver (hereinafter, an adjusting tool) is inserted. The tool insertion portion 49 may have a groove of a hexagonal geometry, so that a hexagonal wrench can be inserted into the tool insertion portion 49. A screwed amount (a screw insert amount) of the adjust screw member 40 with respect to the female screw member 20 is adjusted by rotating the adjusting tool engaged with tool insertion portion 49.

When the screwed amount of the adjust screw member 40 with respect to the female screw member 20, that is, the screw insert amount of the male screw 41 with respect to the female screw 21, is adjusted, the axial position of the adjust screw member 40 in the press direction AD relative to the female screw member 20 is decided. A spring load for the spring member 50 is thereby adjusted to become a target value. The target value for the spring load is set in advance, for example, depending on an oil pressure range of the working oil. A screw gap (not shown), which is suitable for the screw engagement, exists between the female screw 21 and the male screw 41. The adjust screw member 40 can be smoothly rotated in the inside of the female screw member 20 and the screw insert amount can be easily adjusted due to the existence of the screw gap.

In FIG. 2, a first axial distance “D1” is shown as a press-direction distance after the adjustment of the spring load, which is the distance in the press direction AD between the press-force receiving portion 75 formed in the axial end surface 70 of the adjust screw member 40 and an axial end surface 35 formed in the swaged-claw forming portion 30 in the press direction AD. In addition, a second axial distance “D2” is shown as an adjust-screw distance after the adjustment of the spring load, which is the distance in the press direction AD between a reference portion 76 set in advance in the axial end surface 70 of the adjust screw member 40 and an axial end 89 of the sleeve member 81 in the press direction AD. In the present embodiment, a part of the axial end surface 70, which is most protruded in the press direction AD, is set as the reference portion 76. However, any other part of the axial end surface 70 can be set as the reference portion 76.

As explained above, the spring load adjusting device 10 of the present embodiment is applied to the spool valve unit 80 of the linear solenoid valve 100, which is provided in the hydraulic circuit for supplying the working oil to the automatic transmission apparatus of the automotive vehicle. A high sealing property is required for the linear solenoid valve 100, in particular, between the sleeve member 81 and the adjust screw member 40, when the high oil pressure is applied to the linear solenoid valve 100 or when a space for the spring member 50 is used as an oil chamber, such as, a damping chamber, a feedback chamber, a pilot pressure chamber and so on. In the spring load adjusting device 10 of the present embodiment, the swaged-claw forming portion 30 of the female screw member 20 is plastically deformed after the spring load for the spring member 50 is adjusted. The multiple swaged claws 60 are thereby formed and the adjust screw member 40 is pressed by the swaged claws 60 in the first axial direction (in the press direction AD from the spool member 80 to the electromagnetic unit 90), in order to assure the high sealing property.

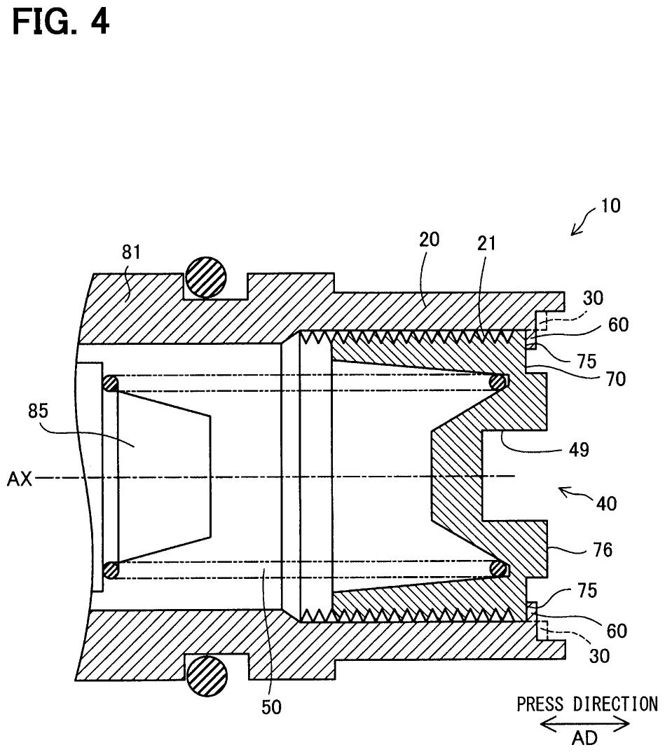

A structure of the swaged claws 60 will be explained with reference to FIGS. 3 and 4. In FIG. 3, for the purpose of simple explanation, each circumferential position of the spring load adjusting device 10 with respect to the center axis AX is indicated by an angle. In FIG. 4, for the purpose of simple explanation, the swaged-claw forming portion 30 before the plastic deformation is indicated by a dotted line. When the swaged-claw forming portion 30 is plastically deformed by the method explained below, the swaged claws 60 are formed which are swaged to the press-force receiving portion 75 of the axial end surface 70 of the adjust screw member 40. In the present embodiment, three swaged claws 60 are so formed that they are arranged at equal intervals in the circumferential direction.

When the adjust screw member 40 is pressed by the swaged claws 60 in the first axial direction (in the press direction AD from the spool member 80 to the electromagnetic unit 90 shown in FIG. 1), a screw thread of the female screw 21 formed in the female screw member 20 and a screw thread of the male screw 41 formed in the adjust screw member 40 are pushed in the first axial direction. The screw thread of the female screw 21 and the screw thread of the male screw 41 are continuously brought into contact with each other along a spiral thread groove formed between the female screw 21 and the male screw 41. Accordingly, the high sealing property can be obtained between the sleeve member 81 and the adjust screw member 40.

### (Structure of Swaging Punch)

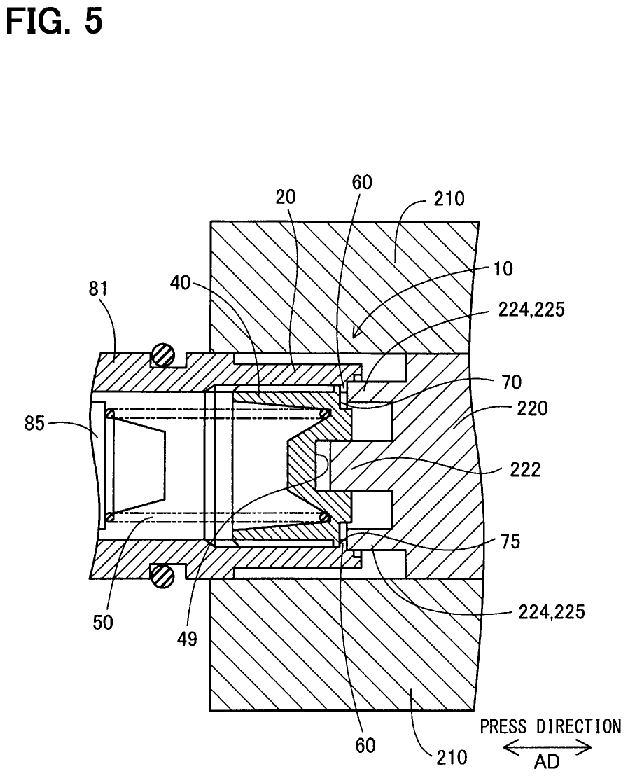

The swaging punch 220 shown in FIG. 5 is used for plastically deforming the swaged-claw forming portion 30 and thereby to form the swaged claws 60 by swaging the portion 30 to the axial end surface 70 of the adjust screw member 40 in the press direction AD. The swaging punch 220 is detachably mounted to a press machine (not shown). The swaging punch 220 is formed in a cylindrical shape and includes a rotation limiting portion 222 and a punching portion 224. In the present embodiment, the punching portion 224 has three punching tooth portions 225 arranged at equal intervals in the circumferential direction. The rotation limiting portion 222 is inserted into the tool insertion hole 49 of the adjust screw member 40 to prevent the adjust screw member 40 from being rotated during a process of forming the swaged claws 60. Each punching tooth portion 225 of the punching portion 224 is protruded in the press direction AD at a position corresponding to the swaged claws 60. Each punching tooth portion 225 of the punching portion 224 is so structured that each of the punching tooth portions 225 is punched to each of the swaged-claw forming portions 30. Each of the swaged claws 60 is respectively formed in the press-force receiving portion 75 of the axial end surface 70 of the adjust screw member 40, wherein each of the swaged claws 60 has a shape and a size corresponding to those of the punching portion 224. In the present embodiment, a cross-sectional shape of each punching tooth portion 225 on a plane perpendicular to the center axis AX is an almost arc shape. The cross-sectional shapes of the punching tooth portions 225 are identical to one another. The cross-sectional shape of the punching tooth portion 225 is not limited to the arc shape. The cross-sectional shapes of the punching tooth portions 225 are not necessarily identical to one another.

The swaging punch 220 is movably inserted into an inside of a guide member 210 having a cylindrical shape. It is suppressed by the guide member 210 that a center axis of the swaging punch 220 is displaced from the center axis AX of the linear solenoid valve 100 when the load is applied to the swaging punch 220. A decrease of accuracy for forming the swaging claws 60 can be suppressed. In the present embodiment, the load is applied to the swaging punch 220 by the press machine, which is hydraulically operated. Hereinafter, the load applied to the swaging punch 220 when forming the swaging claws 60 is referred to as a swaging load.

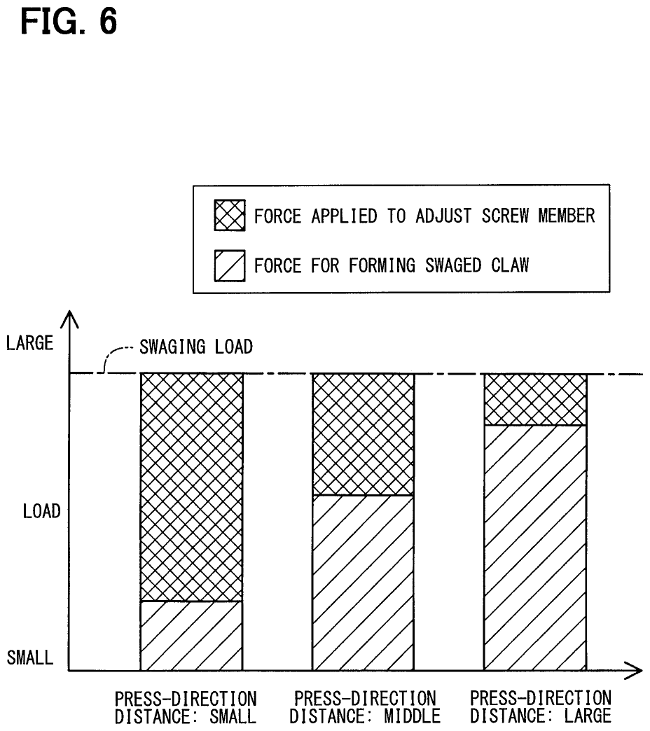

FIG. 6 is a graph for explaining a relationship between the press-direction distance D1 and the swaging load. In FIG. 6, the swaging load applied to the swaging punch 220 is indicated by a one-dot-chain line. In FIG. 6, respective loads of three cases are indicated, wherein three cases include a case in which the press-direction distance D1 is small, a case in which the press-direction distance D1 is middle, and a case in which the press-direction distance D1 is large. The swaging load is composed of a first force necessary for plastically deforming the swaged-claw forming portion 30 and forming the swaged claw 60 and a second force applied to the adjust screw member 40. The second force applied to the adjust screw member 40 corresponds to a force for pushing the adjust screw member 40 in the press direction AD to the spring member 50. The second force is the force necessary for ensuring the sealing property between the sleeve member 81 and the adjust screw member 40.

In the case that the press-direction distance D1 is small, an amount of the plastic deformation of the swaged-claw forming portion 30 is small and therefore the force necessary for forming the swaged claws 60 is small. In a condition that the swaging load is almost constant, a ratio of the second force applied to the adjust screw member 40 with respect to the swaging load becomes larger. On the other hand, in the case that the press-direction distance D1 is large, the amount of the plastic deformation of the swaged-claw forming portion 30 is large and therefore the force necessary for forming the swaged claws 60 is large. Therefore, in the condition that the swaging load is almost constant, the ratio of the second force applied to the adjust screw member 40 with respect to the swaging load becomes smaller. As above, the second force applied to the adjust screw member 40 varies depending on the different press-direction distance D1 after the adjustment of the spring load. In the present embodiment, variation of the second force applied to the adjust screw member 40, which is caused by the different press-direction distance D1, can be suppressed by the spring load adjusting method explained below.

### (Spring Load Adjusting Method)

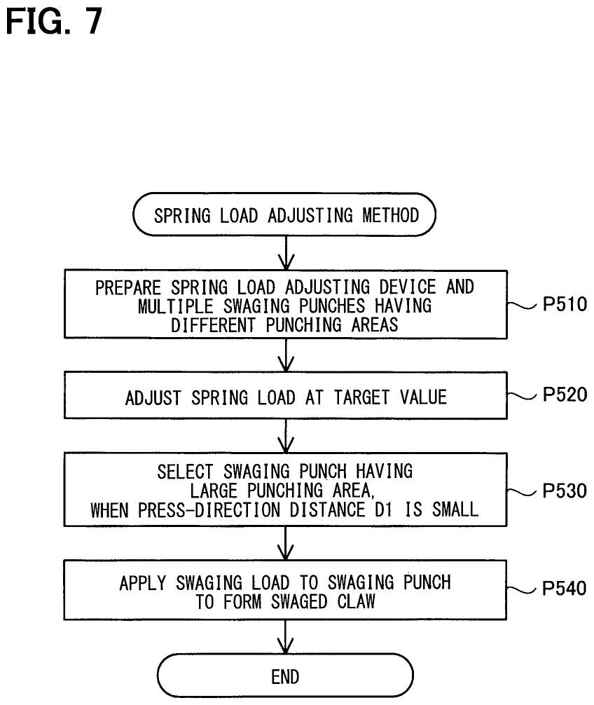

The spring load adjusting method will be explained with reference to FIG. 7. At first, the spring load adjusting device 10 having the above explained structure and multiple swaging punches 220 having different punching areas of the punching portion 224 are prepared at a step P510. The punching area of the punching portion 224 is a sum of the areas of the respective punching tooth portions 225. In the present embodiment, each of the multiple swaging punches 220 has three punching tooth portions 225, wherein a circumferential width CW which is a length of the punching tooth portion 225 in the circumferential direction is different from one another, while a radial width RW which is a thickness of the punching tooth portion 225 in the radial direction is the same to one another. In other words, since the circumferential width CW is different from one another (from the swaging punch to the swaging punch), each of the swaging punches 220 has the different punching area for the punching portion 224 from one another.

The screwed amount between the female screw 21 and the male screw 41 is adjusted in order to adjust the relative position of the adjust screw member 40 to the female screw member 20 in the press direction AD. The spring load for the spring member 50 is thereby controlled at the target value at a step P520.

At a step P530 after the step P520, one of the multiple swaging punches 220 is selected depending on the first axial distance “D1” (the press-direction distance D1) between the axial end surface 35 of the swaged-claw forming portion 30 and the press-force receiving portion 75 formed at the axial end surface 70 of the adjust screw member 40. More exactly, the swaging punch 220 having the large punching area of the punching portion 224 is selected, when the press-direction distance D1 is small (for example, smaller than a first predetermined distance), wherein the punching area of the punching portion 224 is larger than that of the case in which the press-direction distance D1 is large (for example, larger than a second predetermined distance, which is larger than the first predetermined distance). In the present embodiment, therefore, the swaging punch 220 having the large circumferential width CW for the punching tooth portion 225 is selected, when the press-direction distance D1 is small, wherein the circumferential width CW of the punching tooth portion 225 is larger than that of the case in which the press-direction distance D1 is large. In the step P530, one of the multiple swaging punches 220 can be selected, for example, by use of the following method.

As shown in FIG. 2, when the second axial distance D2 (the adjust screw distance D2) is smaller than a predetermined reference range, it is regarded that the first axial distance D1 (the press-direction distance D1) is smaller than a predetermined distance range and the swaging punch 220 having the large circumferential width CW is selected. When the second axial distance D2 (the adjust screw distance D2) is within the predetermined reference range, it is regarded that the first axial distance D1 (the press-direction distance D1) is within the predetermined distance range and the swaging punch 220 having the middle circumferential width CW is selected. When the second axial distance D2 (the adjust screw distance D2) is larger than the predetermined reference range, it is regarded that the first axial distance D1 (the press-direction distance D1) is larger than the predetermined distance range and the swaging punch 220 having the small circumferential width CW is selected. Since it is possible to easily measure the second axial distance D2 (the adjust screw distance D2), it is possible to easily select one of the swaging punches 220 depending on the first axial direction D1 (the press-direction distance D1) when the second axial distance D2 is used. It is alternatively possible to directly measure the first axial direction D1 by omitting the measurement of the second axial direction D2.

As shown in FIG. 7, at a step P540, the swaged-claw forming portion 30 is plastically deformed by the swaging punch 220 selected at the step P530, to which the predetermined swaging load is applied. The swaged claws 60 are thereby formed by swaging the swaged-claw forming portion 30 to the press-force receiving portion 75 formed at the axial end surface 70 of the adjust screw member 40. The swaging load can be set in advance, for example, based on experiments, so that a predetermined fixing force is obtained for pushing the adjust screw member 40 after having formed the swaged claws 60. In the step P540, the adjust screw member 40 is pressed in the press direction AD to the spring member 50 by the predetermined fixing force. When the step P540 is finished, the spool valve unit 80 is completed, wherein the spring load is adjusted and the sealing property is assured.

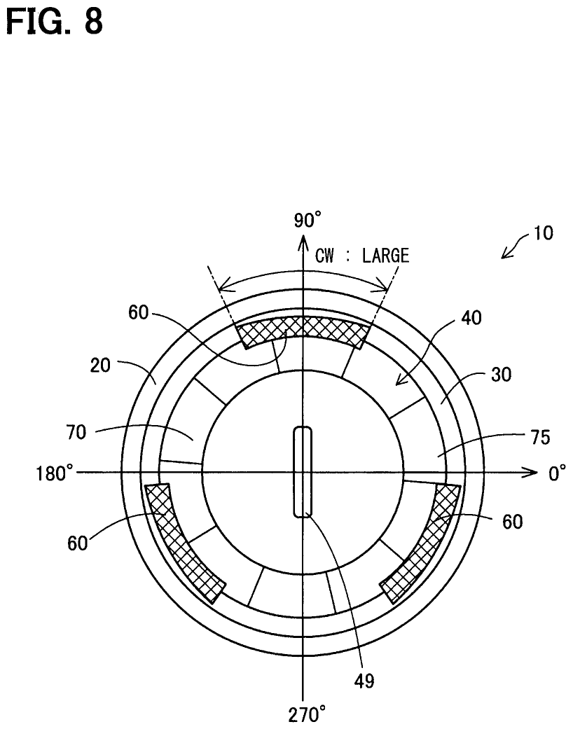

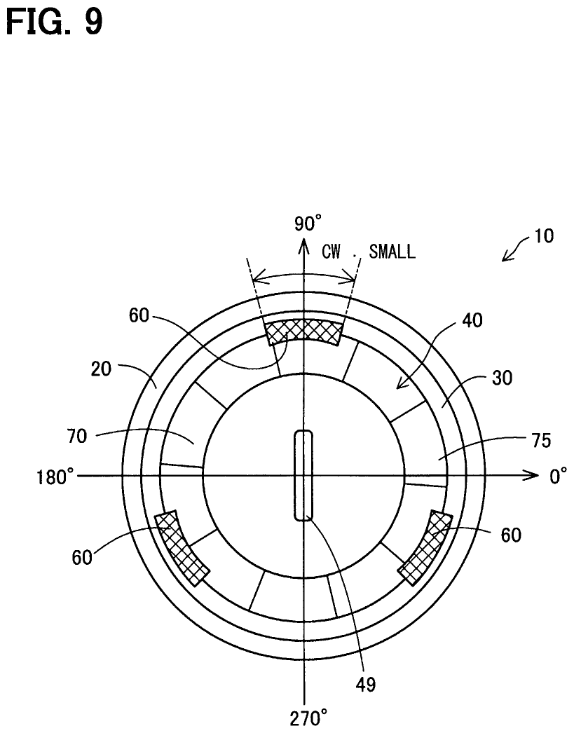

In an example of FIG. 8, the swaged claws 60 are formed by the swaging punch 220 having the large circumferential width CW, while, in an example of FIG. 9, the swaged claws 60 are formed by the swaging punch 220 having the small circumferential width CW. The punching area of the punching portion 224 becomes larger as the circumferential width CW of the punching tooth portion 225 becomes larger. Then, the amount of the plastic deformation becomes larger in the swaged-claw forming portion 30 and the larger swaged claws 60 are formed. As above, when the punching area of the punching portion 224 becomes larger, the force necessary for the plastic deformation becomes larger. In the present embodiment, the circumferential width CW is defined by the length of the punching tooth portion 225 in the circumferential direction along its radial-outer peripheral portion. It is not always necessary to define the circumferential width CW by the radial-outer peripheral portion. The circumferential width CW can be defined by the length of the punching tooth portion in the circumferential direction along a radial-inner peripheral portion. Alternatively, the circumferential width CW can be defined by an angle in the circumferential direction with respect to the center axis AX.

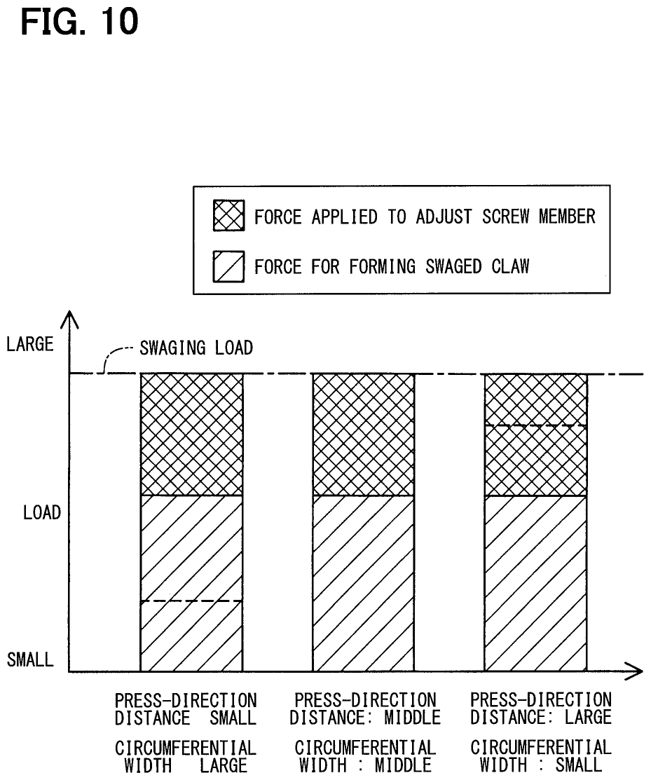

In a similar manner to FIG. 6, in FIG. 10, the swaging load applied to the swaging punch 220 is indicated by the one-dot-chain line. In FIG. 10, respective loads of the three cases are indicated, wherein the three cases include the case in which the press-direction distance D1 is small, the case in which the press-direction distance D1 is middle, and the case in which the press-direction distance D1 is large. In accordance with the step P530 of FIG. 7, when the press-direction distance D1 is small (smaller than the predetermined distance range), the swaging punch 220 having the large circumferential width CW (larger than a second predetermined width) is selected, when the press-direction distance D1 is middle (in the predetermined distance range), the swaging punch 220 having the middle circumferential width CW (larger than a first predetermined width but smaller than the second predetermined width, which is larger than the first predetermined width) is selected, and when the press-direction distance D1 is large (larger than the predetermined distance range), the swaging punch 220 having the small circumferential width CW (smaller than the first predetermined width) is selected. Comparative examples are indicated by dotted lines, in which the swaged claws 60 are formed by the swaging punch 220 of one kind, without preparing the multiple swaging punches 220 and selecting one of them. The dotted lines in FIG. 10 correspond to solid lines in FIG. 6. The dotted line corresponds to a boundary between the first force necessary for plastically deforming the swaged-claw forming portion 30 and forming the swaged claw 60 and the second force applied to the adjust screw member 40.

Since the swaging punch 220 having the large circumferential width CW is selected when the press-direction distance D1 is small, the first force necessary for plastically deforming the swaged-claw forming portion 30 and forming the swaged claw 60 becomes larger when compared with the case in which the multiple swaging punches 220 are not used. As a result, the ratio of the second force to be applied to the adjust screw member 40 with respect to the swaging load becomes smaller, when compared with the case in which the multiple swaging punches 220 are not used. In addition, since the swaging punch 220 having the small circumferential width CW is selected when the press-direction distance D1 is large, the first force necessary for plastically deforming the swaged-claw forming portion 30 and forming the swaged claw 60 becomes smaller when compared with the case in which the multiple swaging punches 220 are not used. As a result, the ratio of the second force to be applied to the adjust screw member 40 with respect to the swaging load becomes larger, when compared with the case in which the multiple swaging punches 220 are not used. As above, in the condition that the swaging load applied to the swaging punch 220 is almost constant, it is possible to avoid a situation that the second force applied to the adjust screw member 40 largely varies, when one of the swaging punches 220 is selected depending on the press-direction distance D1. In FIG. 10, the second force applied to the adjust screw member 40 is almost equal to one another in the three cases, in which the press-direction distance D1 is small, middle and large.

According to the method for adjusting the spring load of the above explained first embodiment, the multiple swaging punches 220 having different punching areas for the punching portion 224 are prepared. The swaged claws 60 are formed by the swaging punch 220 having the large punching area when the press-direction distance D1 is small, wherein the punching area is larger than that of the swaging punch used when the press-direction direction D1 is large. As a result, it is possible to increase the first force necessary for the plastic deformation when the press-direction distance D1 is small. On the other hand, it is possible to decrease the first force necessary for the plastic deformation when the press-direction distance D1 is large. Therefore, in the condition that the swaging load applied to the swaging punch 220 is almost constant, it is possible to avoid the situation that the second force applied to the adjust screw member 40 largely varies, independently from the axial position of the adjust screw member 40 in the press direction after the adjustment of the spring load. Accordingly, it is possible to properly form the swaged claws 60. The high sealing property can be thereby assured between the sleeve member 81 and the adjust screw member 40, while the spring load can be adjusted in a wider range.

In addition, it is possible to avoid the situation that the second force to be applied to the adjust screw member 40 becomes excessively large, when the press-direction distance D1 is small and the first force necessary for the plastic deformation is small. As a result, it is possible to prevent buckling of the adjust screw member 40 and/or the sleeve member 81 and to avoid a situation that unintentional deformation or strain is produced in a portion adjacent to the swaged-claw forming portion 30. Therefore, it is possible to prevent the portion adjacent to the swaged claws 60 or the swaged-claw forming portion 30 from being damaged.

In addition, it is possible to avoid the situation that the second force to be applied to the adjust screw member 40 becomes excessively small, when the press-direction distance D1 is large and the first force necessary for the plastic deformation is large. As a result, it is possible to avoid a situation that a thickness of the swaged claw 60 in the press direction AD becomes excessively small and that the second force applied to the adjust screw member 40 in the press direction AD becomes insufficient. Therefore, it is possible to avoid a situation that the fixing force by the swaged claws becomes insufficient and thereby the sealing property is decreased.

In addition, since the swaging load to be applied to the swaging punch 220 can be maintained at almost the constant value, it is not necessary to make the swaging load excessively large when the press-direction distance D1 is large. As a result, it is possible to prevent the buckling of the adjust screw member 40 and/or the sleeve member 81 and to avoid the situation that the unintentional deformation or strain is produced in the portion adjacent to the swaged-claw forming portion 30. Therefore, it is possible to prevent the portion adjacent to the swaged claws 60 or the swaged-claw forming portion 30 from being damaged. Furthermore, since the swaging load can be maintained at almost the constant value, it is not necessary to make the swaging load excessively small when the press-direction distance D1 is small. As a result, it is possible to avoid the situation that the thickness of the swaged claw 60 in the press direction AD becomes excessively small and thereby the force applied to the adjust screw member 40 in the press direction AD becomes insufficient. Therefore, it is possible to avoid the situation that the fixing force by the swaged claws becomes insufficient and thereby the sealing property is decreased. Accordingly, it is possible to maintain the swaging load at almost the constant value and to obtain the stable fixing force by the swaged claws, when the multiple swaging punches 220 are prepared and selectively used. In addition, since the swaging load can be maintained at almost the constant value, it is possible to eliminate a step for adjusting the swaging load.

In addition, since the multiple swaging punches 220 having the different circumferential width CW are selectively used, it is possible to easily prepare the multiple swaging punches 220 each having the different punching area in the punching portion 224. In addition, since the three punching tooth portions 225 are arranged at the equal intervals in the circumferential direction in each of the swaging punches 220, a circumferential unbalance is not generated in the fixing force to be applied from the swaged claws 60 to the adjust screw member 40.

When the adjust screw member 40 is pressed by the swaged claws 60 in the press direction AD, the screw thread of the female screw 21 and the screw thread of the male screw 41 are continuously brought into contact with each other along the spiral thread groove and the high sealing property can be obtained between the sleeve member 81 and the adjust screw member 40. Since high dimensional accuracy is not required for the engagement gap between the female screw 21 and the male screw 41, it is possible to prevent an increase of the cost for assuring the high sealing property. In addition, it is possible to avoid the situation that the length of the female screw 21 and the male screw 41 in the press direction AD becomes larger in view of assuring the high sealing property and that the length of the spool valve unit 80 and the linear solenoid valve becomes larger in the press direction AD.

### Second Embodiment

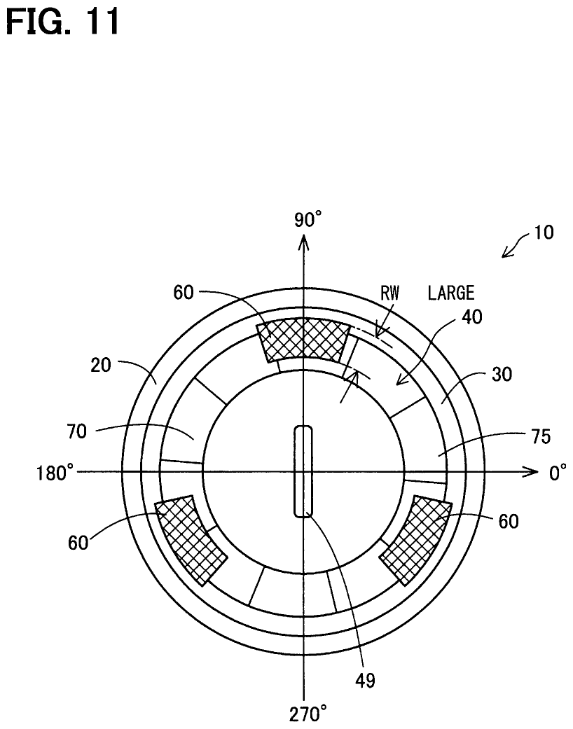

As shown in FIG. 11, the spring load adjusting method according to a second embodiment is different from that of the first embodiment in that the multiple swaging punches 220 having different punching areas in the punching portion 224 are prepared, wherein a radial width RW of the punching tooth portion 225 (that is, the thickness of the punching tooth portion 225 in the radial direction) is different from the swaging punch to the swaging punch. Since the structures of the other portions are the same to those of the first embodiment, the detailed explanation thereof is omitted.

According to the spring load adjusting method of the second embodiment, three different swaging punches 220 are prepared in a step corresponding to the step P510 of FIG. 7, wherein each of the swaging punches 220 has three punching tooth portions 225 and wherein the radial width RW of the punching tooth portion 225 is different from the swaging punch to the swaging punch but the circumferential with CW is the same to one another. In other words, the punching area of the punching portion 224 is different from the swaging punch to the swaging punch, because the radial width RW is different from the swaging punch to the swaging punch. In a step corresponding to the step P530 of FIG. 7, the swaging punch 220 having the large radial width RW for the punching tooth portion 225 is selected when the press-direction distance D1 is small (smaller than the first predetermined distance), wherein the radial width RW is larger than that of the punching tooth portion 225 of the case in which the press-direction distance D1 is large (larger than the second predetermined distance, which is larger than the first predetermined distance). In the example of FIG. 11, the swaged claws 60 are shown, which are formed by the swaging punch 220 having the large radial width RW. The radial width RW of FIG. 11 is larger than that of the case in which the press-direction distance D1 is larger than the second predetermined distance. The punching area of the punching portion 224 becomes larger as the radial width RW of the punching tooth portion 225 becomes larger. Therefore, the amount of the plastic deformation of the swaged-claw forming portion 30 becomes larger, as the punching area of the punching portion 224 becomes larger.

In the present embodiment, the radial width RW is defined by a length in the radial direction along a circumferential-side outer peripheral portion (that is, the distance in the radial direction between a radial-outer end and a radial-inner end). It is not always necessary to define the radial width RW by the length along the circumferential-side outer peripheral portion but the radial width RW can be defined by a length in the radial direction at a circumferential center portion of the punching tooth portion 225.

According to the spring load adjusting method of the above explained second embodiment, the same advantages to those of the first embodiment can be obtained. In addition, since the multiple swaging punches 220 having the different radial width RW in the punching tooth portion 225 are selectively used, it is possible to easily prepare the swaging punches 220 having the different punching areas in the punching portion 224.

### Third Embodiment

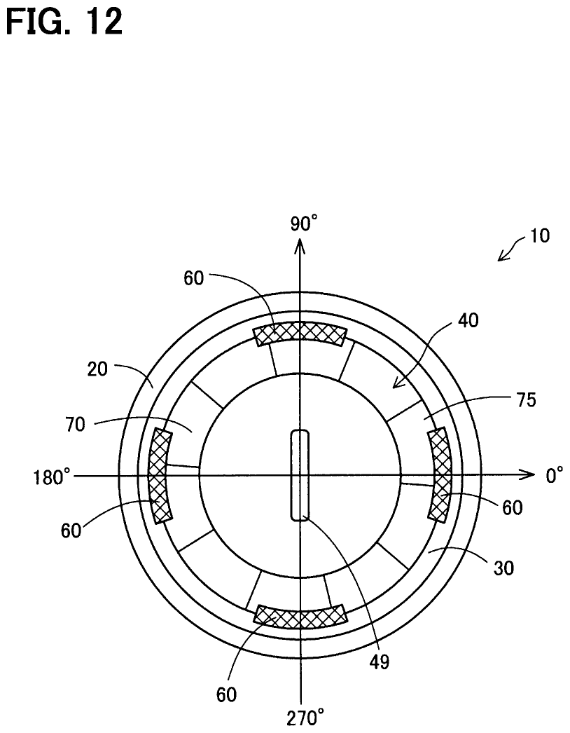

As shown in FIG. 12, the spring load adjusting method according to a third embodiment is different from the first embodiment in that the multiple swaging punches 220 having different punching areas in the punching portion 224 are prepared, wherein the number of the punching tooth portion 225 is different from the swaging punch to the swaging punch. Since the structures of the other portions are the same to those of the first embodiment, the detailed explanation thereof is omitted.

According to the spring load adjusting method of the third embodiment, three different swaging punches 220 are prepared in a step corresponding to the step P510 of FIG. 7, wherein the circumferential width CW and the radial width RW of the punching tooth portion 225 are the same to one another but the number of the punching tooth portion 225 is different by one from the swaging punch to the swaging punch. In other words, the punching area of the punching portion 224 is different from the swaging punch to the swaging punch, because the number of the punching tooth portion 225 is different from the swaging punch to the swaging punch. In a step corresponding to the step P530 of FIG. 7, the swaging punch 220 having the larger number of the punching tooth portions 225 is selected when the press-direction distance D1 is small (smaller than the first predetermined distance), wherein the number of the punching tooth portions 225 is larger than that of the punching tooth portions 225 of the case in which the press-direction distance D1 is large (larger than the second predetermined distance). In the example of FIG. 12, the swaged claws 60 are formed by the swaging punch 220 having four punching tooth portions 225. The punching area of the punching portion 224 becomes larger as the number of the punching tooth portion 225 becomes larger. Therefore, the amount of the plastic deformation of the swaged-claw forming portion 30 becomes larger, as the number of the punching tooth portion 225 becomes larger.

According to the spring load adjusting method of the above explained third embodiment, the same advantages to those of the first embodiment can be obtained. In addition, since the multiple swaging punches 220 having the different number of the punching tooth portion 225 are selectively used, it is possible to easily prepare the swaging punches 220 having the different punching areas in the punching portion 224.

### Fourth Embodiment

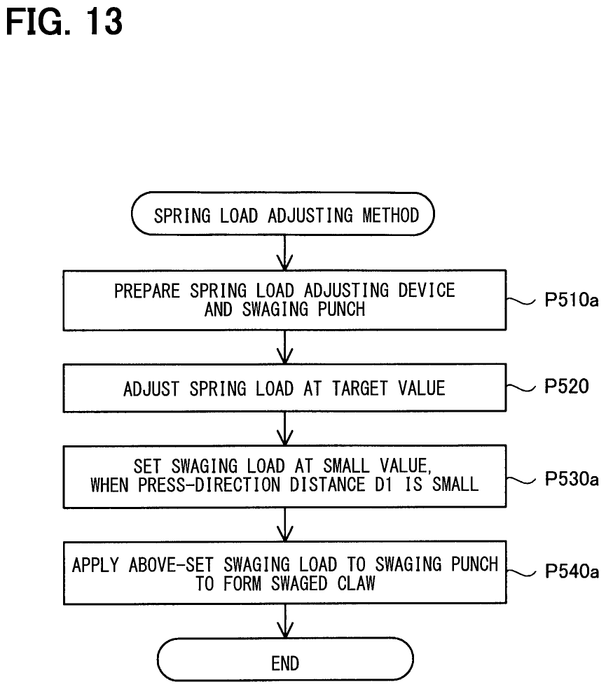

As shown in FIG. 13, the spring load adjusting method according to a fourth embodiment is different from the first embodiment in that the swaging punch 220 of one kind is used instead of the multiple swaging punches and the swaged claws 60 are formed with the swaging load, which is changed depending on the press-direction distance D1. Since the structures of the other portions are the same to those of the first embodiment, the detailed explanation thereof is omitted.

According to the spring load adjusting method of the fourth embodiment, the spring load adjusting device 10 of the above explained structure and the swaging punch 220 of one kind are prepared in a step P510a of FIG. 13. The screwed amount between the female screw 21 and the male screw 41 is adjusted in order to adjust the relative position of the adjust screw member 40 to the female screw member 20 in the press direction AD. The spring load for the spring member 50 is thereby controlled at the target value in the step P520.

At a step P530a after the step P520, the swaging load is set depending on the press-direction distance D1 between the swaged-claw forming portion 30 and the press-force receiving portion 75 formed at the axial end surface 70 of the adjust screw member 40. More exactly, the swaging load is set at a small value when the press-direction distance D1 is small (smaller than the first predetermined distance), wherein the swaging load value set as above is smaller than a swaging load value to be set in the case that the press-direction distance D1 is large (larger than the second predetermined distance). The value to be set for the swaging load may be selected from three or five values, which are in advance set in a stepwise manner. Alternatively, the value to be set for the swaging load may be decided based on the press-direction distance D1 and by use of a predetermined relational expression. In a case that the value to be set for the swaging load is selected from the three values of the stepwise manner, the swaging load is set in the step S530a according to the method explained below.

When the adjust screw distance D2 shown in FIG. 2 is smaller than the predetermined reference range (that is, smaller than the first predetermined amount), it is regarded that the press-direction distance D1 is smaller than the predetermined distance range (that is, smaller than the first predetermined distance) and the swaging load is set at a small value (smaller than a first predetermined load). When the adjust screw distance D2 is within the predetermined reference range (that is, between the first and the second predetermined amounts), it is regarded that the press-direction distance D1 is within the predetermined distance range (between the first and the second predetermined distances) and the swaging load is set at a middle value (between the first predetermined load and a second predetermined load larger than the first predetermined load). When the adjust screw distance D2 is larger than the predetermined reference range (larger than the second predetermined amount), it is regarded that press-direction distance D1 is larger than the predetermined distance range (larger than the second predetermined distance) and the swaging load is set at a large value (larger than the second predetermined load). It is possible to easily set the swaging load at one of the selected values depending on the press-direction distance D1 by use of the adjust screw distance D2. As an alternative method, it is possible to directly measure the press-direction distance D1 instead of measuring the adjust screw distance D2.

As shown in FIG. 13, in a step P 540a, the swaging load, which is set in the step P530a, is applied to the swaging punch 220 and the swaged-claw forming portion 30 is plastically deformed to form the swaged claws 60 swaged to the press-force receiving portion 75 formed at the axial end surface 70 of the adjust screw member 40.

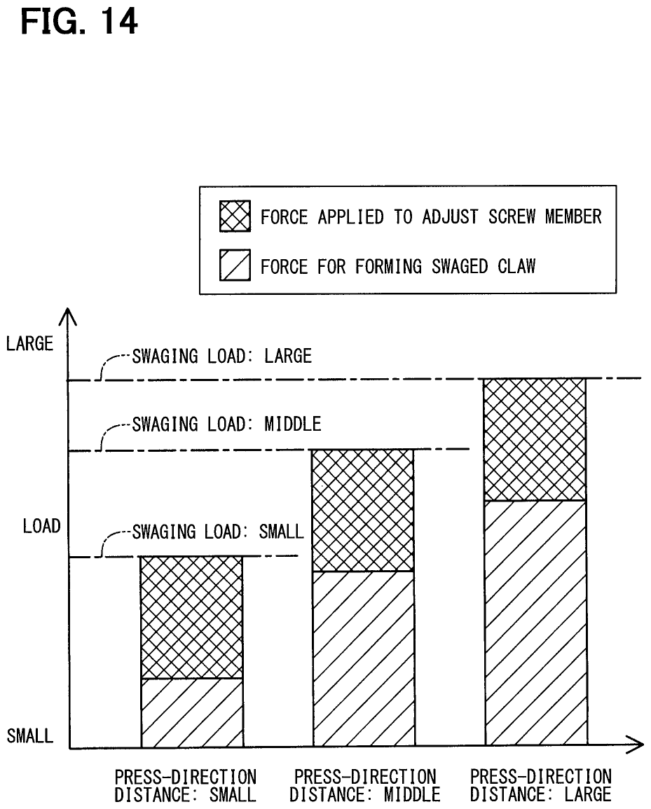

In a similar manner to FIG. 6, in FIG. 14, the swaging load applied to the swaging punch 220 is indicated by the one-dot-chain lines. In FIG. 14, respective loads of the three cases are indicated, wherein the three cases include the case in which the press-direction distance D1 is small, the case in which the press-direction distance D1 is middle, and the case in which the press-direction distance D1 is large. When the press-direction distance D1 is small (smaller than the first predetermined distance), the swaging load is set at the small value (smaller than the first predetermined load) in the step P530a of FIG. 13. When the press-direction distance D1 is middle (between the first and the second predetermined distances), the swaging load is set at the middle value (between the first and the second predetermined loads). When the press-direction distance D1 is large (larger than the second predetermined distance), the swaging load is set at the large value (larger than the second predetermined load).

The first force necessary for plastically deforming the swaged-claw forming portion 30 and forming the swaged claws 60 is small (smaller than a first predetermined force), when the press-direction distance D1 is small. Therefore, when the swaging load is set at the small value (smaller than the first predetermined load) in the case that the press-direction distance D1 is small, it is possible to avoid the situation that the second force to be applied to the adjust screw member 40 becomes excessively large (larger than a first predetermined amount). On the other hand, the first force necessary for plastically deforming the swaged-claw forming portion 30 and forming the swaged claws 60 is large (larger than a second predetermined force), when the press-direction distance D1 is large. Therefore, when the swaging load is set at the large value (larger than the second predetermined load) in the case that the press-direction distance D1 is large, it is possible to avoid the situation that the second force to be applied to the adjust screw member 40 becomes insufficient.

As above, when the swaging load to be applied to the swaging punch 220 is set and changed depending on the press-direction distance D1, it is possible to avoid the situation that the second force to be applied to the adjust screw member 40 largely varies. In the example of FIG. 14, the second force to be applied to the adjust screw member 40 is controlled at almost the same value among the three cases, including the case in which the press-direction distance D1 is small, the case in which the press-direction distance D1 is middle, and the case in which the press-direction distance D1 is large.

According to the spring load adjusting method of the above explained fourth embodiment, the same advantages to those of the first embodiment can be obtained. In addition, since it is not necessary to prepare the multiple swaging punches 220, it is possible to reduce the cost for manufacturing the swaging punch 220.

In addition, it is not always necessary to set the swaging load in the stepwise manner but the swaging load can be set at a value, which is continuously changed. In such a case, the variation of the second force, which is decided depending on the press-direction distance D1 and which is applied to the adjust screw member 40, can be further suppressed.

### Further Embodiments and/or Modifications

(M1) In the above first to third embodiments, the three swaging punches 220, each having the different punching area for the punching portion 224 from the other swaging punches, are prepared, and one of them is selected to form the swaged claws 60. However, the number of the swaging punches to be prepared is not limited to three but can be two, four, five or any other optional number. Then, one of those multiple swaging punches is selected to form the swaged claws 60.

In addition, one swaging punch may be prepared, in which punching tooth portions 225 having different punching areas are combined. In such a modified swaging punch, multiple punching tooth portions having the different punching areas are alternately arranged in the circumferential direction and each of the punching tooth portions is movable in the press direction AD, so that the punching tooth portion is selectively moved in the press direction AD. In the modified swaging punch, the selected punching tooth portion is protruded in the press direction AD to the spring load adjusting device 10 and the swaging load is applied to the swaging punch. Even in such a modification, the same advantages to those of the first to the third embodiments can be obtained.

(M2) In the above first to third embodiments, the multiple punching tooth portions 225 are arranged at equal intervals in the circumferential direction. However, the multiple punching tooth portions 225 may be arranged at different intervals.

In the above second embodiment, the punching portion 224 may be so modified to have one punching tooth portion 225 entirely extending in the circumferential direction. In such a modification, the punching area of the punching portion 224 differs from the swaging punch to the swaging punch due to the difference of the radial width RW of the punching portion 224.

In addition, the swaging punches 220 of the above first to the third embodiments may be combined to one another. In such a modification, for example, the swaging punch having the large punching area for the punching portion 224 can be prepared, wherein the number of the punching tooth portions 225 is increased and the radial width RW is increased. The swaging punch having the small punching area for the punching portion 224 can be likewise prepared, when the number of the punching tooth portions 225 is decreased and the circumferential width CW is decreased. According to such modifications, flexibility of designing the punching portion 224 can be increased and the punching portions 224 having different punching areas can be easily prepared.

(M3) The spring load adjusting method of the above first to third embodiments and the spring load adjusting method of the fourth embodiment can be combined to each other. For example, in the case that the press-direction distance D1 is small, the small swaging load is applied to the swaging punch 220 having the large punching area in the punching portion 224 to form the swaged claws 60. On the other hand, in the case that the press-direction distance D1 is large, the large swaging load is applied to the swaging punch 220 having the small punching area in the punching portion 224 to form the swaged claws 60. According to such a modification, it is possible to increase the flexibility for designing the method for adjusting the spring load.

(M4) In the above first to third embodiments, the swaging punch 220 is detachably mounted to the swaging press machine. However, it may be so modified that each of the multiple swaging punches is in advance mounted to a rotating member or a sliding member of the swaging press machine. In such a modification, it is possible to reduce time necessary for replacing the swaging punches.

In addition, in each of the above embodiments, the swaging punch 220 is mounted to the swaging press machine which is operated by the oil pressure. However, the swaging press machine can be also modified in various manners. For example, the swaging press machine can be operated by air pressure, by electric power, or even by manual operation. In the case that the swaging press machine is manually operated in the fourth embodiment, the step P530a and the step P540a can be carried out concurrently. Even in the above modifications, the same advantages to the above embodiments can be obtained.

(M5) The press-force receiving portion 75, which is formed at the axial end surface 70 of the adjust screw member 40, can be modified in various manners. For example, multiple inclined surfaces may be formed in the axial end surface 70, wherein each of the inclined surfaces is inclined in different directions with respect to a plane perpendicular to the center axis AX. In such a modification, a rotational force is given by the inclined surface to the adjust screw member 40 in a screw fastening direction or a screw unfastening direction, when the adjust screw member 40 is pressed in the press direction AD. According to such a modification, it is possible to avoid a situation that the relative position of the adjust screw member 40 to the sleeve member 81 in the press direction AD is moved after the adjustment of the spring load due to vibration, impact or the like. In other words, it is possible to avoid the situation that the spring load varies after the adjustment of the spring load.

(M6) The spring load adjusting device 10 of the above embodiments is applied to the spool valve unit 80 of the linear solenoid valve 100. The driving portion for the spool valve unit 80 is not limited to the electromagnetic unit 90. Any other types of the driving portion, for example, any other type of actuators, a pilot oil pressure or the like can be used as the driving portion. In addition, the spring load adjusting device can be applied not only to the spool valve unit 80 for controlling the oil pressure to be supplied to the automatic transmission apparatus but also to any other type of the spool valve unit for which the sealing property is required between the sleeve member 81 and the adjust screw member 40. Furthermore, the spring load adjusting device may be applied to a valve device, for which the sealing property is required between the female screw member 20 and the adjust screw member 40.

The present disclosure is not limited to the above embodiments and/or the modifications and can be further modified in various manners without departing from a spirit of the present disclosure.

What is claimed is:

1. A method for adjusting spring load comprising;
a step for preparing a spring load adjusting device, which includes;
a spring member;
a female screw member of a cylindrical shape having a female screw formed at its inner peripheral surface, wherein the female screw member has a swaged-claw forming portion at its axial end in a press direction for pushing the spring member; and
an adjust screw member having a male screw formed at its outer peripheral surface and engaged with the female screw, wherein the adjust screw member adjusts the spring load for the spring member depending on a relative position of the adjust screw member with respect to the female screw member in the press direction;
a step for preparing multiple swaging punches for plastically deforming the swaged-claw forming portion and forming a swaged claw plastically deformed to an axial end surface of the adjust screw member in the press direction, wherein each of the swaging punches has a punching portion to be brought into contact with the swaged-claw forming portion and a punching area of the punching portion differs from the swaging punch to the swaging punch;
a step for adjusting the spring load for the spring member by adjusting the relative position of the adjust screw member with respect to the female screw member in the press direction;
a step for selecting one of the swaging punches to be used for forming the swaged claw in a way that,
when a press-direction distance in the press direction between an axial end surface of the swaged-claw forming portion and the axial end surface of the adjust screw member is smaller than a predetermined distance range, the swaging punch having a large punching area is selected, wherein the large punching area is larger than a punching area of another swaging punch which is selected when the press-direction distance is larger than the predetermined distance range; and
a step for applying a predetermined swaging load to the swaging punch selected in the above step and press forming the swaged claw, wherein the adjust screw member is pushed by the swaged claw in the press direction to the spring member.

2. The method for adjusting spring load according to claim 1, wherein
the punching portion has multiple punching tooth portions arranged in a circumferential direction of the adjust screw member.

3. The method for adjusting spring load according to claim 2, wherein
a circumferential width of the punching tooth portion differs from the swaging punch to the swaging punch.

4. The method for adjusting spring load according to claim 2, wherein
number of the punching tooth portion differs from the swaging punch to the swaging punch.

5. The method for adjusting spring load according to claim 2, wherein
a radial width of the punching tooth portion differs from the swaging punch to the swaging punch.

6. A method for adjusting spring load comprising;
a step for preparing a spring load adjusting device, which includes;
a spring member;
a female screw member of a cylindrical shape having a female screw formed at its inner peripheral surface, wherein the female screw member has a swaged-claw forming portion at its axial end in a press direction for pushing the spring member; and
an adjust screw member having a male screw formed at its outer peripheral surface and engaged with the female screw, wherein the adjust screw member adjusts the spring load for the spring member depending on a relative position of the adjust screw member with respect to the female screw member in the press direction;
a step for preparing a swaging punch for plastically deforming the swaged-claw forming portion and forming a swaged claw plastically deformed to an axial end surface of the adjust screw member in the press direction;
a step for adjusting the spring load for the spring member by adjusting the relative position of the adjust screw member with respect to the female screw member in the press direction; and
a step for applying a swaging load to the swaging punch and press forming the swaged claw, wherein the adjust screw member is pushed by the swaged claw in the press direction to the spring member,
wherein, when a press-direction distance in the press direction between an axial end surface of the swaged-claw forming portion and the axial end surface of the adjust screw member is smaller than a predetermined distance range, a first swaging load is applied to the swaging punch, which is smaller than a second swaging load to be applied to the swaging punch when the press-direction distance is larger than the predetermined distance range.
